(19) United States
(12) Patent Application Publication
(10) Pub. No.: US 2004/0179430 A1
(43) Pub. Date: Sep. 16, 2004

(54) Pill dispensing reminder capable of communicating with a remotely situated computer

(76) Inventors: Reuben Bahar, West Hills, CA (US); Irit Romano, Tel-Aviv (IL)

Correspondence Address: Bahar, Reuben, 23708 Welby Way, West Hills, CA, 91307, US

(21) Appl. No.: 10/388,718

(22) Filed: Mar. 13, 2003

(51) Int. Cl. G04B 47/00

(52) U.S. Cl. 368/10

(57) ABSTRACT

A medicament reminder for keeping a patient informed of medicament related matter which is capable of communicating with a remotely situated computer through the use of wireless technology. A microprocessor is held in a case and includes a wireless transceiver. The reminder may receive data messages from the computer informing its user of important medical data while also enabling the user to transmit data messages to the computer. Data messages transmitted from the reminder to the computer include response request inquiries pertaining to specific medical issues a patient may have. A warning indicator held by the case may output a signal at triggered warning events.

### BACKGROUND OF THE INVENTION

The field of the invention is medicament reminders and the invention relates more particularly to a reminder for informing a patient of important information pertaining to medicaments.

There has been a long term trend of developing new drugs and nutritional supplements which have greatly improved the control of diseases as well as improving the health of the patient. Additionally, there has also been a long term increase in human life expectancy. The combination of these trends has led to both a requirement for taking more than one medicine by a patient as well as a tendency for the patient to be of advanced years and in need of assistance in keeping informed of important information pertaining to the medicines which they are taking or need to take.

For example, a patient may be compelled to regularly take a medication, such as thyroxine, throughout the course of their life. This would require that they continuously refill the prescription each time it ran low. Unfortunately, many patients often forget to order the refill until the medicament is totally consumed and a few days have passed by. This results in the patient having deprived themselves of needed medication which, in some cases, can be extremely dangerous to their health. Moreover, in situations where the patient is extremely busy, naturally forgetful, elderly, or taking a few medicines at the same time, the chances for greater delays in refilling a needed prescription(s) increases tremendously.

Numerous pill dispensing systems have been devised in an effort to help patients remember when to take a specific medication. One such device is shown in U.S. Pat. No. 6,507,275, which is incorporated by reference herein. While this pill dispensing reminder can inform its user when to take a particular medicine it is incapable of communicating with a remotely situated medical facility. In other words, the user is unable to relay or receive (through the reminder) data messages pertaining to the medicaments which they are taking or need to take.

### BRIEF SUMMARY OF THE INVENTION

The present invention is for a pill dispensing reminder which is capable of communicating with a remotely situated medical facility. The reminder includes a case for supporting a microprocessor which has a timing element and a memory element capable of receiving and sending medicament related data to an output port which may be connected to a liquid crystal display screen. A data link interface is preferably held by the case for receiving medicament related data such as inputted programming data pertaining to medicament dosage times, conditions and name-identifying indicia for at least one time interval during a successive 24 hour periods. The reminder of the present invention further has a transceiver which receives and/or transmits medicament related data, via wireless technology, between the reminder and a remotely situated computer. A warning indicator may be held by the case and includes element(s) for producing an output signal that informs the patient of significant information regarding one or more medicament(s) and similarly related medical issues.

### BRIEF DESCRIPTION OF THE DRAWINGS

FIG. 1 is a diagrammatic perspective view of a medicament reminder capable of receiving and sending data through wireless technology.

FIG. 2 is a diagrammatic view of a personal computer connectable to the reminder of FIG. 1.

FIG. 2′ is a diagrammatic view of a personal hand held computer connectable to the reminder of FIG. 1.

FIG. 3 is a diagrammatic view of a remotely situated computer capable of communicating with the reminder of FIG. 1 via wireless technology.

FIG. 4 is one embodiment of a menu displaying three message templates that a user of the reminder may use to compose a message on the reminder of FIG. 1.

### DETAILED DESCRIPTION OF THE PREFERRED EMBODIMENTS

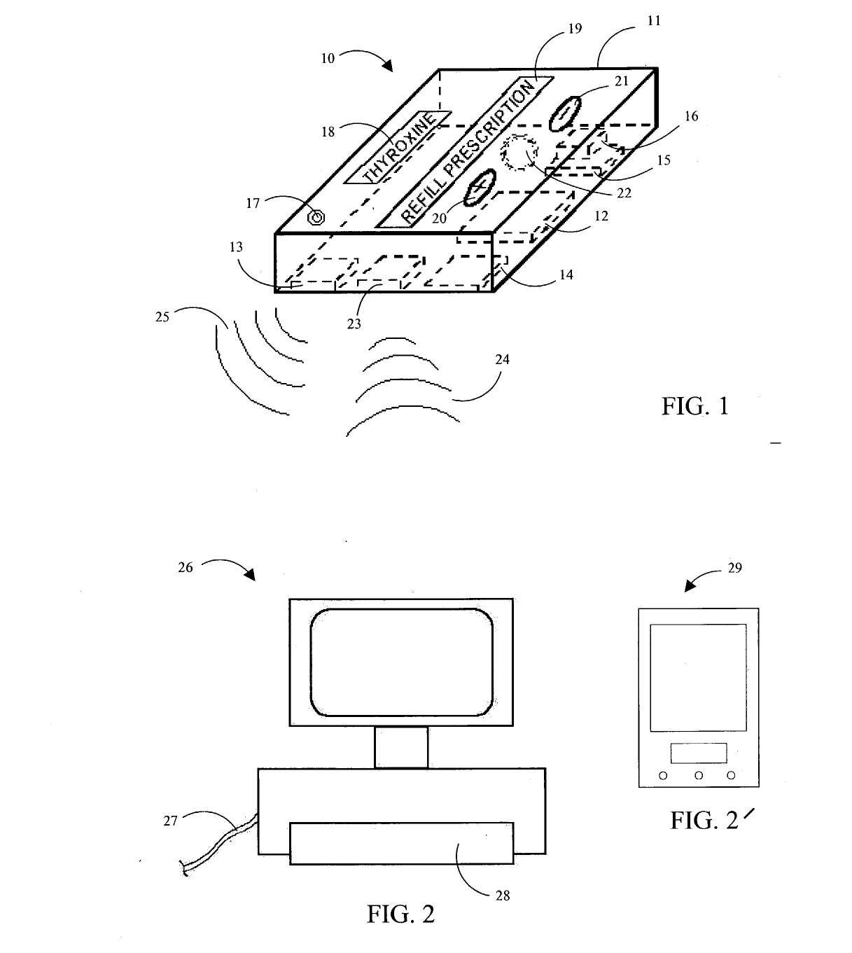

The medicament reminder (hereinafter, “reminder”) is shown in plan view in FIG. 1 and indicated generally by reference character 10. Reminder 10 has a case portion 11 which provides a housing for the reminder 10 and contains its electronic components and circuitry. The term “medicament(s)” as used herein is intended to include any digestible vitamin, mineral, or medicine in an oral dosage form, such as a tablet or capsule, and is not intended to be limited to prescription drugs. The term is also intended to include nutritional supplements and other over-the-counter pills or capsules taken by patients. Likewise, the term may also refer to medicines in liquid or pressurized form (such as injections, syrup, or inhalers) which can be gotten by prescription or bought over-the-counter. It is further noteworthy that the term “medical facility”, as used herein, is intended to include any facility or station that provides medicaments, medical service(s), counseling, advice, and/or other type of medical care. This includes, but is not limited to pharmacies and other medicament dispensing/service facilities, hospitals, medical offices (e.g. public and private practitioners), mobile units (e.g. ambulances, mobile medical trailers), clinics, retail stores, learning institutions (e.g. universities, schools), and any other facility that may be involved in the medical profession/industry. Finally, the term patient as used herein and in the claims, is intended to include any user or potential user of the reminder 10 of this invention.

Case 11 is shown in FIG. 1 having a microprocessor 12 which interfaces with element for programming 13, data output element 14, timing element 15, which has a 24 hour clock, and transceiver 23. A memory element 16, which is preferably non-volatile, is likewise interfaced with microprocessor 12 and is capable of sending medicament related data to data output element 14 at pre-programmed, triggered, or user chosen time intervals. Additionally, data output element 14 is also capable of receiving medicament related data from the element for programming 13 and transceiver 23. A wafer battery 22 is further held by the case 11 as a power element for providing the microprocessor 12 with a source of energy. Although not shown, the case 11 may include one or more compartments for holding a medicament.

Medicament related data includes but is not limited to information pertaining to a medicament(s) a patient is taking or may need to take. For example, medicament related data may consist of medicament identifying data, dosage times, and “conditions”. It is noteworthy that the term “conditions” as used herein is intended to include, but is not limited to, directions for taking a medicament(s), such as “take with food”, “to be taken twice a day”, or “do not take X medicament if taking Y medicament”. Medicament related data is also intended to include informative data related to a patient's medical history, past and present medical condition(s), medicament(s) a patient is taking or needs to take, advertisements, and any other data that pertains to a patient's use of medicament(s) or medical disposition. Furthermore, medicament related data may refer to data that identifies a particular patient such as, but not limited to, name, address, phone number(s), assigned user account data (e.g. medical record number(s), medicament reminder identification code, etc.). It is noteworthy that medicament related data may be inputted into and outputted out of the reminder 10 via a direct data link connection, infrared data transmission, and/or wireless data transmission.

A data link interface 17 is held by the case 11 for receiving and transmitting medicament related data such as programming data to and from the reminder 10. Programming data, for example, may be received and transmitted between the reminder 10 and a personal computer, FIG. 2 character reference 26, a hand held computer (e.g. Palm®), FIG. 2′ character reference 29, or other electronic device capable of communicating with the reminder 10. A direct link set up between the reminder 10 and any of these devices will allow an individual (whether a medicament professional or patient) to input and extract data from the reminder 10. Inputting of data will allow for programming of the reminder 10, while extraction of data will allow for a patient or medicament professional to pull out programmed data resident in the reminder 10. For example, if ever comes a time when a patient is unable to communicate their medical information to a medicament professional (e.g. doctor), critical medical data stored in the reminder 10 may be retrieved by the professional. Although the data link interface 17 is shown as a port through which a direct wire connection to the microprocessor 12 may be established, the data link interface 17 may also include or be an infrared port which allows for wireless data transfer utilizing infrared or other similar type technology.

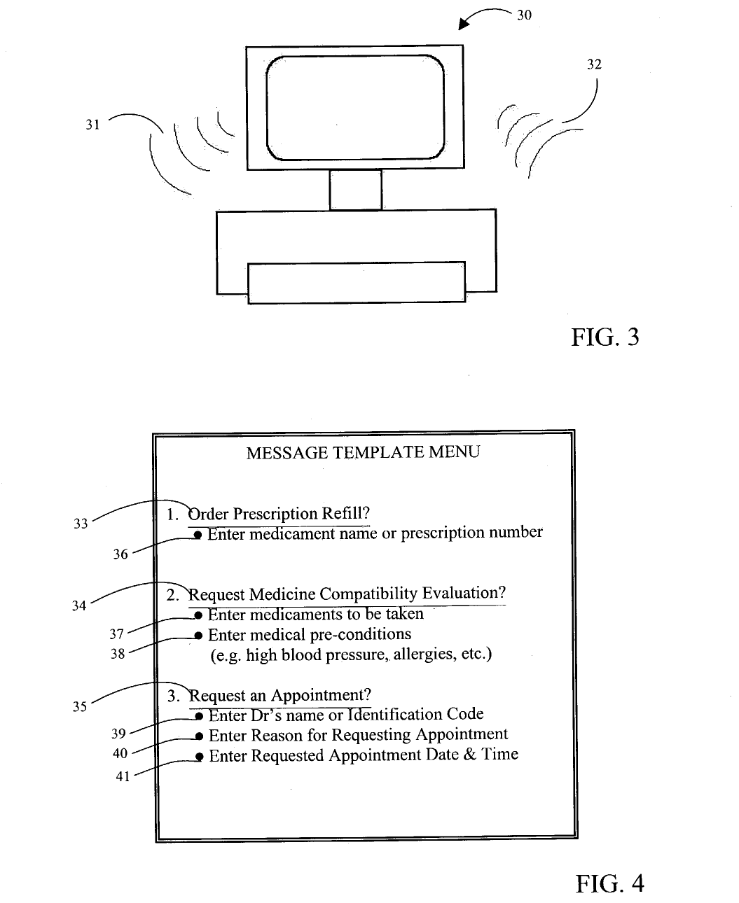

Medicament related data may also be received by and transmitted from the reminder 10 via transceiver 23 which utilizes wireless technology to communicate with a remotely situated computer terminal 30, as shown in FIG. 3. This is the heart of the present invention and enables various communication and information sharing benefits with use of the reminder 10. While the remotely situated computer terminal 30 may be set up in almost any location (stationary or mobile), preferably, it is based within a medical facility where trained medical personnel would be available. Corresponding to prior reference, this may include a pharmacy as well as a hospital and/or medical office. Non-stationary locations may include, but are not limited to an ambulance and/or mobile medical facility. Additionally, each medical facility may have one or more then one remotely situated computer terminals 30 set up to communicate with medicament reminders 10.

As referenced in FIG. 3, wireless data transmission technology is used to transmit data from the remotely situated computer terminal 30 (reference character 31) to the reminder's 10 transceiver 23 (reference character 24 FIG. 2). Additionally, data may also be transmitted, via wireless technology, from the reminder's 10 transceiver 23 (reference character 25 FIG. 2), to the remotely situated computer terminal 30 (reference character 32 FIG. 3). Although wireless data transmission may be achieved with cellular technology, use of hard wire telephone lines (as an intermediate), radio frequency technology, and/or satellite technology, the optimal method(s) for establishing wireless communication between the computer 30 and transceiver 23 is best known to those skilled in the art, and thus, need not be mentioned herein.

The ability to send and receive data via wireless technology between the reminder 10 and a remotely situated computer 30 would allow both a patient and medical facility to be informed of important medical data at times when such communication is needed. Communication may be initiated by either the patient or medical facility in regards to any critical or non-critical medical (especially medicament) related issue(s). Additionally, with the use of automated messaging, routine communication between the patient (e.g. through use of their reminder 10) and medical facility could occur on a regular basis without becoming overly time consuming. In this respect, both the medical facility and the user of the reminder 10 may communicate with one another from any location at any given time of the day.

For example, the medical facility may transmit to the patient's reminder 10 important information about medicaments the patient is taking or going to take that was not previously disclosed or realized. Given the health implications associated with medicaments, receiving such information as soon as it is realized may prove invaluable. Similarly, the patient, in turn, may transmit data messages to the medical facility which the facility may store and/or transmit a reply to, depending on the issue at hand. Thus, the functions offered by wireless data transmission may not only be of “life saving” importance, but may furthermore, offer the patient efficiency and convenience. This is especially true for individuals who are always “on the go” and unable to effectively communicate with their medical facility in regards to vital medicament issues. It is noteworthy that data transmitted from the remotely situated computer 30 (ref. character 31) to the reminder 10 (ref. character 24) may be created by trained medical personnel operating the computer terminal 30. Alternatively, these data transmissions may be prepared and transmitted (reference character 31) by the computer 30 which would operate independently on an automated program protocol.

Despite the countless reasons for wireless message transmissions between a medical facility and a patient, some are of particular significance. In accordance with one embodiment of the present invention, the reminder 10 may be used to communicate with a medical facility, such as a pharmacy, for the purpose of conveying information in regards to prescribed medicaments. For example, patients who order one or more medicaments from a pharmacy may be informed that their order is ready for pick-up upon readiness of the order. In this manner, once the prescription has been prepared for the patient, the medical facility may transmit 31 a message to the patient's reminder 10 (reference character 24) informing them of the readiness of their order. If the patient fails to pick up their prescription within a predetermined time period (e.g. day), a subsequent message may be transmitted 31 to the patient's reminder 10 (reference character 24) informing them of the situation.

A further example would pertain to patients who are prescribed a particular medicament(s) for a continuous period of time, thereby regularly needing to refill their prescription. Unfortunately, all too often, these patients forget to place a refill order until their medicament is totally expired. Even at that point, some patients may put off placing the order due to time constraints or forgetfulness. As one solution to this predicament, the medical facility may program its computer terminal(s) 30 with the date and time at which the patient's medicament prescription is expected to be consumed. A warning message, reminding the patient to refill their prescription, may thereafter be transmitted 31 to the patient's reminder 10 (reference character 24) at a predetermined date and time period(s). If after a predetermined time period (e.g. 3 days) the patient has still not re-ordered their needed medication, a subsequent message(s) may, once again, be transmitted 31 to their reminder 10 (reference character 24).

It is noteworthy that given the reminder's 10 capability of transmitting 25 data messages to the medical facility, the patient may be able to re-order their prescription via direct message transmission from their reminder 10 (reference character 25). For instance, upon receiving (on the reminder 10) a “prescription re-order” warning from the medical facility, the patient may re-transmit 25 a message to the medical facility confirming the prescription re-order. This would conveniently eliminate the need for the patient to either call in their order or physically travel to the medical facility to place the order. Additionally, even without a “prescription re-order” message from the medical facility, the patient may independently transmit 25 a message for ordering their needed prescription. If after the prescription order is processed the patient has still not picked up the medicament, a subsequent message may be transmitted 31 to their reminder 10 (reference character 24) in a similar manner as mentioned above.

In another embodiment, the reminder 10 may be used to update the patient's medical history record as certain events occur. For example, each time the patient consumes a medicament (e.g. pill), the reminder 10 may be programmed as such. That data may thereafter be transmitted 25 to the remotely situated central computer 30 which would record and track the information. Such accumulated data could thereafter be analyzed in regards to the patient's medicament ingestion regarding taken and missed doses. The resulting information could prove invaluable to parties (e.g. doctors) concerned with the patient's medical health. Of course, it is contemplated that the patient may input other types of data into the reminder 10 which may also be transmitted to the medical facility computer 30 in order to update their medical history record.

In yet another embodiment, the reminder may be used to remind the patient of time/date sensitive information such as medical appointments, scheduled tests, etc. A reminder message informing of the upcoming event may be transmitted 31 to the reminder 10 (reference character 24) at an appropriate time prior to the scheduled event. It is notable that in all embodiments mentioned in this invention, data contained in the patient's medical record may be shared with, accessed by, and/or stored in the remotely situated computer terminal 30. Thus, with regards to this embodiment, the computer 30 would automatically initiate a transmission 31 to the patient's reminder 10 (reference character 24) at the pre-programmed time/date to inform them of the time/date sensitive information (e.g. a scheduled appointment).

It is noteable that even when the medical facility is closed, trained medical personnel may nevertheless, be present at a remotely situated computer terminal 30 on a 24/7 basis. In this respect, they would receive (FIG. 3, ref. character 32) medicament related question data from patients and be able to transmit (FIG. 3, ref. character 31) corresponding response data on a real time basis. When, however, trained medical personnel are unavailable, the remotely situated computer terminal 30 may be set up to automatically receive medicament related data, process such data, and transmit an appropriate response to a patient's reminder 10. One scenario where an automatically processed response would effectively operate pertains to matters of medicament compatibility.

For example, a patient may need to know whether a particular medicament is compatible with other medicament(s) they have taken or are planning to take. Given the danger in taking medications that are incompatible with other medications, this issue is of significant importance and warrants immediate feedback. For such occurrences, the remotely situated computer 30 may contain a database consisting of pre-programmed data which can determine the compatibility of one medicament to another. All the patient would have to do is input (into the reminder 10) data pertaining to the medicament(s) they are intending to take and transmit 25 it to the remotely situated computer 30 (reference character 32). The computer 30, in return, would generate a response by cross-referencing the received data with information contained in its database. Additionally, by further accessing the patient's medical record, the computer 30 may be able to provide a more detailed response in accordance with the patient's listed medical dispositions. The response would then be processed into a message and transmitted 31 from the computer 30 to the patient's reminder 10 (reference character 24).

The patient may likewise undergo a similar process for determining whether they may even take a particular medicament(s) on account of a pre-existing health condition(s). For example, if the patient has high blood pressure, they would transmit 25 a data message inquiring whether a particular medicament(s) may be taken in light of that condition. After receiving 32 the message, the remotely situated computer 30 would access data on the requested medicament(s) for determining whether it can cause high blood pressure. The response would thereafter, be processed and transmitted 31 to the patient's reminder 10 (reference character 24). In this manner, a patient may attain proper confirmation of a medicament related compatibility issue at the moment that issue arises, regardless of whether the medical facility is open or occupied by any personnel at the computer 30. Of course, the same medicament compatibility analysis may be accomplished by a trained individual operating the computer 30 at times when one would be available, but as the examples show, such need not be the case.

In yet another embodiment, the reminder 10 may be used to schedule a medical appointment with the medical facility. In this scenario, a patient may enter data (into the reminder 10) requesting an appointment with a particular practitioner on an approximate date and time. The message would thereafter be transmitted 25 from the reminder 10 to the remote computer 30 (reference character 32) for suggesting a specific appointment date and time. The determined timeframe may thereafter be transmitted 31 to the same reminder 10 (reference character 24) for patient acceptance or rejection.

The ability to transmit 31 data, via wireless technology, to the reminder 10 will further allow the medical facility to send a patient advertisements. Advertisements may depict, but are not limited to the following: products, stores, messages (warning and non-warning), slogans, logos, trademarks, trade names, etc. Furthermore, advertisements may be presented in either written (e.g. text) or pictorial form, or a combination of both. An advertisement may be viewed on a display window of the reminder 10 such as LCD 18 or 19 shown in FIG. 1. Additionally, a sound generating element such as a speaker (not shown) may further be attached to the reminder 10 to allow for sound to be heard from the reminder, especially when an advertisement is being viewed. It is noteworthy that the same advertisements may be transmitted 31 to all reminders 10 or alternatively, different advertisements may be transmitted to different reminders 10. As will later be discussed in detail, it is preferred that each reminder 10 have a unique identification code/number which would allow it and its user to be independently recognized from other reminders 10 and their users. This will allow for selective advertising among the recognized users of the reminder 10. For example, a reminder 10 with identification code/number “5555” which belongs to a patient suffering from asthma may receive advertisements pertaining to inhalers which are on sale at the medical facility or other outlet location. On the other hand, a reminder 10 with identification code/number “6666” which belongs to a patient suffering from depression may receive message advertisements indicating when and where the next anti-depression group meeting will be held at.

As previously mentioned, data transmissions transmitted from the computer 30 would preferably be created by a trained medicament professional operating the computer 30. Alternatively, they may be electronically created by a program installed in computer 30 for providing automated responses to specifically recognized and/or decipherable medicament issues (e.g. drug compatibility). Data transmissions transmitted from the reminder 10, on the other hand, are preferably created by the user of the reminder 10 via one or a combination of the following non-exclusive methods. The first such method allows for the message to be typed from a computer program resident on an external data inputting machine such as a PC 26 with attached keyboard 28, FIG. 2 or hand held unit 29, FIG. 2′. The computer program can be supplied to the patient on a disk or made available online through a web site. An established data link from either the PC 26 or hand held 29 to the reminder 10 (e.g. via a wire connection 27 from the PC 26 to the data link interface 17 of reminder 10) would permit the patient to download the programmed data into the microprocessor 12 or memory element 16 of the reminder 10. Another method would entail use of an alphanumeric keyboard (not shown) that is attached to the reminder 10 for creating the message. Finally, a third method entails use of selection buttons 20 and 21, which are resident on the reminder 10 for providing the patient with element(s) for inputting and/or manipulating programming data.

Although a computer program resident on the PC 26 would greatly simplify the patient's task of programming the reminder 10, such a program resident in the reminder 10 would further work to simplify the task. This would allow the patient to easily input data, such as a message, into the reminder 10 at any time or location, especially when an external data inputting machine (e.g. a PC 26 or hand held computer 29) is not available. The program resident in the reminder 10 may utilize various message templates which have generic short answer replies. When the patient desires to transmit a message to the remotely situated central computer 30, they may simply pick the template corresponding to their question and compose the desired message. Various message templates may be programmed on a central menu within the reminder 10 for easy selection access. For example, as shown in FIG. 3, a menu containing three types of message templates presents possible messages a patient may transmit 25 from their reminder 10 to a remotely situated computer 30. There, the first message template 33 states, “Order Prescription Refill”, a second 34 states, “Request Medicine Compatibility Evaluation”, while a third 35 states, “Request an Appointment”, etc. Furthermore, each message template may contain subsequent questions that are provided for composing the appropriate message. Thus, under the first message template 33, a subsequent question asking the patient to “Enter the medicament name or prescription number” 36 is provided. Similarly, under the second message template, subsequent questions, “Enter medicaments to be taken” 37 and “Enter medical pre-conditions” 38 are provided. Finally, under the third message template, subsequent questions, “Enter Dr.'s name or identification code” 39, “Enter reason for requesting appointment” 40, and “Enter requested appointment data and time” 41 are provided.

Preferably, the message templates would require minimal input from the patient for generating a message and would further contain pre-programmed response data (such as names of various medicaments) which the patient can select from in order to compose their message. This would enable otherwise complex messages to be quickly created via use of selection buttons 20 and 21. It is noteworthy that where the patient desires to transmit a particular message for which a template was not provided for in the reminder 10, they may be able to create a customized message template containing their desired question/request. Creation of a custom message template may be accomplished by drafting the template using a supplied computer program running on either a PC 26 or hand held unit 29, and thereafter, downloading it into the memory element 16 of the reminder 10. As such, it. is understood that notwithstanding the examples stated herein, countless other message templates may be programmed in the reminder 10 for use in response requested messages.

It is preferred that each reminder 10 have its own programmed identification code which will allow the remotely situated computer 30 to differentiate it from other reminders 10. Distinguishing between reminders 10 is important since much of the communications between the reminder 10 and computer 30 would involve data that is distinct and personal to a particular patient. Of course, commonly applicable messages may be transmitted 31 from the computer 30 to all reminders 10, however, a critical feature of the present invention pertains to communications that are of personal nature to a particular patient. As such, one method of distinguishing between reminders would involve assigning each a unique identification code or serial number. Similar to the method in which pagers and/or cellular telephones function, each reminder 10 would be able to automatically receive and transmit personalized data under its assigned identification signature. Each unique code/number would preferably be programmed into a distinct reminder 10, thereby allowing the computer 30 to recognize which patient's reminder 10 a particular message originated from. Similarly, data transmitted 31 from the computer 30 in accordance with a particular identification code/number would only be received by the reminder 10 which was assigned that particular identification code/number.

In the absence of each reminder having a programmed identification code/number, a patient may manually enter (into their reminder 10) personal identification data (e.g. drivers license, medical record number, etc.) along with any message transmission 25 to the computer 30. In this manner the remotely situated computer 30 would be able to identify the patient through their identification data upon receipt 32 of the transmitted 25 message. With regards to message replies, the computer 30 may process a response message(s) into a downloadable file that corresponds to a patient's personal identification data. The patient may thereafter establish a link to the computer 30 (e.g. via a call initiated from the reminder 10) and download the reply message file corresponding to the personal identification data which they would enter. Despite the above mentioned scenarios, other methods for distinguishing between reminders which are best known to those skilled in the art may exist and thus, need not be mentioned herein.

It is preferred that the reminder 10 contain a warning indicator such as an audible alarm, a luminous alarm, a vibrating alarm, or any combination of the three, that will output a warning signal upon the occurrence of a warning event. Warning events may be initiated due to various reasons including, but not limited to, pre-programmed time intervals and/or triggered occurrences. For example, a pre-programmed time interval may pertain to a time when a medicament is to be taken, while a triggered occurrence may pertain to the receipt of a message from the remotely situated computer 30, etc. The warning signal may be sent from data output element 14 and may further be initiated in conjunction with a data message displayed on either of first LCD 18 (such as, “thyroxine”), or second LCD 19 (such as “refill prescription”), FIG. 1, of reminder 10.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A medicament reminder capable of communicating with a remotely situated computer comprising:
a case for supporting circuitry;
a microprocessor held by said case including element for programming the microprocessor and data output element, said microprocessor including a 24 hour clock and integrated with a memory element;
a data display window held by said case to display alpha/numeric data;
a transceiver that is capable of communicating with said remotely situated computer via the use of wireless technology;
a power element held by said case for providing a source of electrical energy to said microprocessor.
programming data sending element independent of said case to permit programming of said microprocessor, said memory element, or a combination thereof;

2. The medicament reminder of claim 1 further comprising:
a warning indicator held by said case including an element to output a signal at a warning event;

3. The medicament reminder of claim 2, wherein said warning indicator is an audible signal outputting device, a vibrating signal outputting device, a luminous signal outputting device, or a combination thereof.

4. The medicament reminder of claim 1, further comprising a sound generating element.

5. The medicament reminder of claim 1, wherein said data display window is a liquid crystal display screen.

6. The medicament reminder of claim 1, wherein said data transmitted from said remotely situated computer to said reminder is generated in accordance with input from personnel operating said computer.

7. The system of claim 1, wherein said data transmitted from said remotely situated computer to said reminder is generated solely by said computer in accordance with a program protocol.

8. The medicament reminder of claim 1, wherein said remotely situated computer is located within a medical facility.

9. The medicament reminder of claim 8, wherein said medical facility is a pharmacy, a hospital, a medical office, a learning institution, or a combination thereof.

10. The medicament reminder of claim 1, wherein said communication comprises a task reminding message, a message pertaining to medicament compatibility, an advertisement, or a combination thereof.

11. A medicament reminder capable of communicating with a remotely situated computer comprising:
a case for supporting circuitry;
a microprocessor which processes data;
a memory element which stores data;
a transceiver that is capable of communicating with said remotely situated computer via the use of wireless technology;
a power element which provides electrical energy to said microprocessor.

12. The medicament reminder of claim 11 further comprising:
at least one data display window which displays alpha/numeric data.

13. The medicament reminder of claim 11 further comprising:
a sound generating element.

14. The medicament reminder of claim 11 further comprising:
programming data sending element to permit programming of said microprocessor, said memory element, or a combination thereof.

15. The medicament reminder of claim 14, wherein said programming sending element is independent of said case.

16. The medicament reminder of claim 14, wherein said programming sending element comprises an alphanumeric keyboard attached to said case.

17. The medicament reminder of claim 11 further comprising:
a warning indicator for outputting a warning signal at a warning event.

18. The medicament reminder of claim 11, wherein said microprocessor comprises a timing element which includes a 24 hour clock.

19. The medicament reminder of claim 11, wherein said remotely situated computer is located within a medical facility.

20. The medicament reminder of claim 19, wherein said medical facility is a pharmacy, a hospital, a medical office, a learning institution, or a combination thereof.

21. The medicament reminder of claim 11, wherein said communication comprises a task reminding message, a message pertaining to medicament compatibility, an advertisement, or a combination thereof.

22. A system for communicating between a remotely situated computer and a medicament reminder, said system comprising:
a medicament reminder that is kept within the possession of a patient and comprising:
a case for supporting circuitry;
a microprocessor which processes data;
a memory element which stores data;
a transceiver that is capable of communicating with said remotely situated computer via the use of wireless technology;
a power element which provides electrical energy to said microprocessor; and
a remotely situated computer which is configured to communicate with said reminder via the use of wireless technology.

23. The system of claim 22, wherein said data transmitted from said remotely situated computer to said reminder is generated in accordance with input from personnel operating said computer.

24. The system of claim 22, wherein said data transmitted from said remotely situated computer to said reminder is generated solely by said computer in accordance with a program protocol.

25. The system of claim 22, wherein said remotely situated computer is located within a medical facility.

26. The system of claim 25, wherein said medical facility is a pharmacy, a hospital, a medical office, a learning institution, or a combination thereof.

27. The system of claim 22, wherein said communication comprises a task reminding message, a message pertaining to medicament compatibility, an advertisement, or a combination thereof.

28. A method of communication between a medicament reminder and a remotely situated computer, said method comprising the steps of:
providing a user with a medicament reminder, said reminder capable of transmitting data, receiving data, or a combination thereof, via the use of wireless technology, and configured to communicate with a remotely situated computer via the use of said wireless technology;
establishing a remotely situated computer capable of transmitting data, receiving data, or a combination thereof, via the use of wireless technology, and configured to communicate with said medicament reminder via the use of said wireless technology.
creating a data communication to be transmitted;
transmitting said data communication to said medicament reminder or said remotely situated computer.

29. The method of claim 28, wherein said communication comprises a task reminding message, a message pertaining to medicament compatibility, an advertisement, or a combination thereof.

30. The method of claim 28, wherein said remotely situated computer is located within a medical facility.

31. The method of claim 30, wherein said medical facility is a pharmacy, a hospital, a medical office, a learning institution, or a combination thereof.
